(19) United States
(12) Patent Application Publication
(10) Pub. No.: US 2009/0262204 A1
(43) Pub. Date: Oct. 22, 2009

(54) NOTEBOOK COMPUTER

(75) Inventors: Tung-Hsuan Pai, Taipei (TW); Chi-Jen Liao, Taipei (TW); Wen-Lung Chou, Taipei (TW); Wei-Chih Teng, Taipei (TW); Ming-Yueh Guu, Taipei (TW); Meng-Tsung Su, Taipei (TW)

Correspondence Address: KIRTON AND MCCONKIE, 60 EAST SOUTH TEMPLE,, SUITE 1800, SALT LAKE CITY, UT, 84111, US

(73) Assignee: PRIMAX ELECTRONICS LTD., Taipei (TW)

(21) Appl. No.: 12/241,265

(22) Filed: Sep. 30, 2008

(30) Foreign Application Priority Data
Apr. 18, 2008 (CN) 200810093345.0

(51) Int. Cl. H04N 5/225

(52) U.S. Cl. 348/207.11; 348/E05.024

(57) ABSTRACT

The present invention relates to a notebook computer for capturing an image of a card. The notebook computer includes a base and an upper cover. The base includes a keyboard and a fixing recess for fixing the card. The upper cover is pivotally coupled to the base and includes an image sensing device and a screen for displaying a frame. If the image sensing device is disenabled to capture the image of the card, the frame on the screen has a first luminance value. Whereas, if the image sensing device is enabled to capture the image of the card, the frame on the screen has a second luminance value greater than the first luminance value.

### FIELD OF THE INVENTION

The present invention relates to a notebook computer, and more particularly to a notebook computer for capturing an image of a card.

### BACKGROUND OF THE INVENTION

Notebook computers or laptop computers have experienced great growth and are now rapidly gaining in popularity. Due to the advantages of small size, light weightiness and easy portability, notebook computers become essential components for the businessmen when travelling to other places or taking part in meetings. With increasing development of multimedia techniques, the commercial available notebook computer is usually equipped with an image sensing device such as a network camera or a camera to capture the image of the user. Therefore, the notebook computer can be used for holding a video conference or providing an on-line communication service.

On the other hand, after the user has visited customers or taken part in a meeting, the basic information associated with the business cards of the customers or conferees needs to be filed in order to quickly search the basic information in the further. For convenience, after the image of the card is captured by the image sensing device, the image data can be immediately recognized or filed by associated software or hardware components of the notebook computer. Moreover, it is also convenient to capture the images of other documents having size similar to the business card by the image sensing device of the notebook computer. An example of the document includes but is not limited to a business card, a photograph, a credit card, a debit card, an identification card, an envelope, a postcard, a ticket card, a notepaper, a bookmark and the like.

### SUMMARY OF THE INVENTION

It is an object of the present invention to provide a notebook computer having an image sensing device for facilitating a user to capture an image of a card.

Another object of the present invention provides a notebook computer having an image sensing device, in which the notebook computer has a mechanism for fixing a card without additionally purchasing or carrying a card stand.

In accordance with an aspect of the present invention, there is provided a notebook computer for capturing an image of a card. The notebook computer includes a base and an upper cover. The base includes a keyboard and a fixing recess for fixing the card. The upper cover is pivotally coupled to the base and includes an image sensing device and a screen for displaying a frame. If the image sensing device is disenabled to capture the image of the card, the frame on the screen has a first luminance value. Whereas, if the image sensing device is enabled to capture the image of the card, the frame on the screen has a second luminance value greater than the first luminance value.

In an embodiment, a white frame is displayed on the screen if the image sensing device is enabled to capture the image of the card.

In an embodiment, the notebook computer further comprises a touch pad, whose level is lower with respect to a top surface of the base, so that an indentation between the top surface of the touch pad and the base is defined as the fixing recess.

In an embodiment, the fixing recess is a groove comprising an entrance and an inclined channel.

In an embodiment, the entrance is located in a top surface of the base.

In an embodiment, the entrance is located in a front surface of the base.

In an embodiment, the entrance is located in a junction between a top surface of the base and a front surface of the base.

In an embodiment, the notebook computer further comprises a sound generating device, wherein a sound prompt is generated by the sound generating device if an included angle between the upper cover and the base is within a preset angle range.

In an embodiment, the sound generating device is a loudspeaker.

In an embodiment, the notebook computer further comprises a lighting device, wherein a light beam is emitted by the lighting device if an included angle between the upper cover and the base is within a preset angle range.

In an embodiment, the lighting device is a light emitting diode.

In an embodiment, a flashing picture is shown on the screen if an included angle between the upper cover and the base is within a preset angle range.

In an embodiment, the upper cover is pivotally coupled with the base about a rotating shaft, and a tenon is mounted within the rotating shaft, such that a noise is generated if an included angle between the upper cover and the base is within a preset angle range.

In an embodiment, the included angle between the upper cover and the base is retained by the tenon.

In an embodiment, the notebook computer further comprises a switch, and the switch is triggered to allow the image sensing device to capture the image of the card if an included angle between the upper cover and the base is within a preset angle range.

In an embodiment, the switch is a key of the keyboard.

In an embodiment, the preset angle range is greater than 10° and smaller than 90°.

In an embodiment, the image sensing device is an image pickup device.

In an embodiment y, the image pickup device is a network camera.

In an embodiment, the image pickup device is a camera.

In an embodiment, the card is selected from a group consisting of a business card, a photograph, a credit card, a debit card, an identification card, an envelope, a postcard, a ticket card, a notepaper and a bookmark.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view of a notebook computer according to a preferred embodiment of the present invention;

FIGS. 2A, 2B and 2C are schematic side views illustrating three exemplary grooves formed in different positions of the base of the notebook computer for fixing the card; and

FIGS. 3A, 3B, 3C and 3D are schematic side views illustrating four exemplary positioning auxiliary devices used in the notebook computer of the present invention to notify the user that the included angle between the upper cover and the base is within a preset angle range.

### DETAILED DESCRIPTION OF THE PREFERRED EMBODIMENT

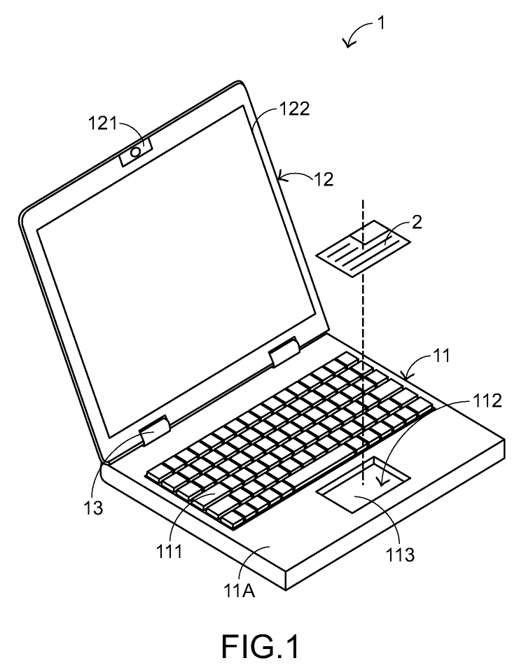

FIG. 1 is a schematic perspective view of a notebook computer according to a preferred embodiment of the present invention. The notebook computer 1 has an image sensing device for capturing an image of a card 2. The notebook computer 1 comprises a base 11 and an upper cover 12. The base 11 is the main body of the notebook computer 1 and contains the components for implementing basic operations of the notebook computer 1. A keyboard 111 and a fixing recess are formed in the top surface 11A of the base 11. The fixing recess can be used for fixing the card 2 on a proper position. For fixing the card 2 on a proper position, the edges of the card 2 is contacted with sidewalls of the fixing recess or the card 2 is clamped. In an embodiment, a touch pad 113 is disposed on the base 11. There is a level difference between the touch pad 113 and the top surface 11A of the base 11. An indentation 112 between the top surface of the touch pad 113 and the base 11 can be defined as the fixing recess. After the card 2 is directly mounted within the indentation 112 or the edges of the card 2 is contacted with sidewalls of the indentation 112, the image of the card 2 is captured by the image sensing device.

Please refer to FIG. 1 again. The upper cover 12 of the notebook computer 1 is pivotally coupled with the base 11 about a rotating shaft 13. The upper cover 12 comprises an image sensing device 121 and a screen 122. The screen 122 is a display device that displays frames. An example of the image sensing device 121 includes but is not limited to a network camera or a camera to capture the image of the card 2. After the image of the card 2 is captured by the image sensing device 121, the image data is recognized, filed or stored by associated software or hardware components of the notebook computer 1.

In accordance with a key feature of the present invention, the luminance of the screen 122 is automatically increased during the image of the card 2 is captured by the image sensing device 121. The increase of the screen luminance may help the user successfully capture the image of the card 2. Even if the user of the notebook computer 1 is positioned in a dim environment, the increase of the screen luminance will illuminate the card 2 such that the image captured by the image sensing device 121 is clear. For example, if the notebook computer 1 executes a word processing program or other application programs without using the image sensing device 121, the luminance of the screen 122 is given as a first luminance value. For a purpose of using the image sensing device 121 to capture the image of the card 2, an image pickup program is opened. When the image pickup program is executed, the luminance of the screen 122 is automatically adjusted to a second luminance value greater than the first luminance value, so that a clear image of the card 2 is captured by the image sensing device 121. In some embodiments, when the image pickup program is executed, the screen 121 of the notebook computer 1 displays a white or light-colored frame to allow the image sensing device 121 to capture a clear image of the card 2.

In the above embodiment, the indentation 112 between the top surface of the touch pad 113 and the base 11 is used as the fixing recess for fixing the card 2. It is noted that, however, those skilled in the art will readily observe that numerous modifications and alterations may be made while retaining the teachings of the invention. For example, a groove formed in the base 11 of the notebook computer may be used as the fixing recess so to as clamp the card 2.

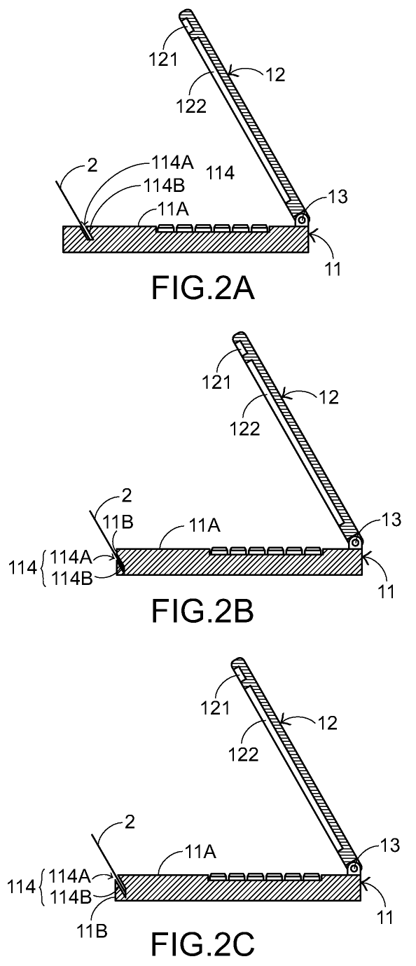

FIGS. 2A, 2B and 2C are schematic side views illustrating three exemplary grooves formed in different positions of the base of the notebook computer for fixing the card. As shown in FIG. 2A, the groove 114 includes an entrance 114A and an inclined channel 114B. The entrance 114A is located in the top surface 11A of the base 11. After the card 2 is inserted into the inclined channel 114B, the card 2 is made upright and inclined. By slightly rotating the upper cover 12 such that the card 2 is directly in front of the image sensing device 121, the image of the card 2 will be completely captured by the image sensing device 121. In addition, since more light beams emitted from the bright frame of the screen 122 are projected on the card 2, a clear image of the card 2 may be captured by the image sensing device 121. As shown in FIG. 2B, the groove 114 of the notebook computer 1 also includes an entrance 114A and an inclined channel 114B. In this embodiment, the entrance 114A is located in the front surface 11B of the base 11. After the card 2 is inserted into the inclined channel 114B, the card 2 is also made upright and inclined. As shown in FIG. 2C, the groove 114 of the notebook computer 1 also includes an entrance 114A and an inclined channel 114B. In this embodiment, the entrance 114A is located in the junction between the top surface 11A and the front surface 11B of the base 11. In the above embodiments, since the fixing recess of the notebook computer is able to fix the card 2 on a proper position, the card 2 needs not be held by hand and thus the card 2 is not subject to hand shaking. In addition, the notebook computer 1 is very convenient and user-friendly because the user needs not additionally purchase or carry a card stand.

Depending on the sizes of the notebook computer 1, the sensing ranges for the image sensing device 121 on the upper cover 12 are varied. In accordance with another key feature of the present invention, the notebook computer 1 further includes a positioning auxiliary device. After the image pickup program is opened and a proper included angle between the upper cover 12 and the base 11 is adjusted, the positioning auxiliary device will issue a prompt signal to notify the user that the card 2 is positioned within the sensing range of the image sensing device 121. Under this circumstance, the image of the card 2 is captured by the image sensing device 121 automatically or in response to an image capture instruction. Generally, if the included angle between the upper cover 12 and the base 11 is controlled to be greater than 10° and smaller than 90°, the image of the card 2 will be effectively sensed by the image sensing device 121. if the included angle between the upper cover 12 and the base 11 is controlled to be greater than 30° and smaller than 80°, the image of the card 2 captured by the image sensing device 121 is clearer. Hereinafter, some exemplary positioning auxiliary devices used in the notebook computer 1 of the present invention will be illustrated in more details.

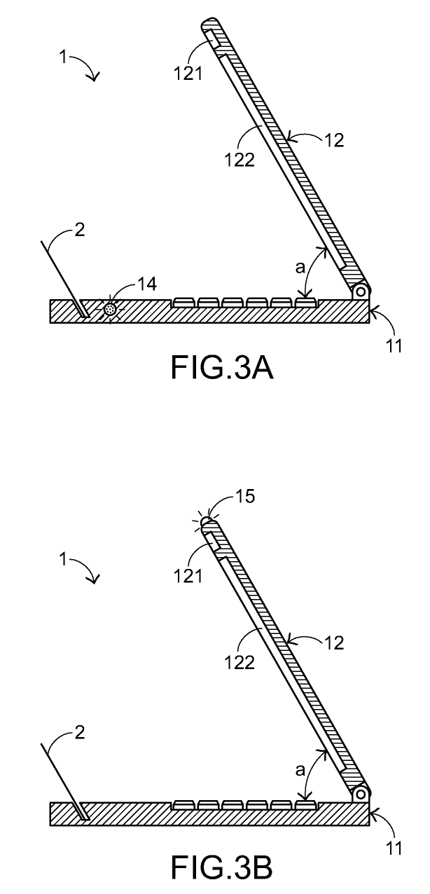

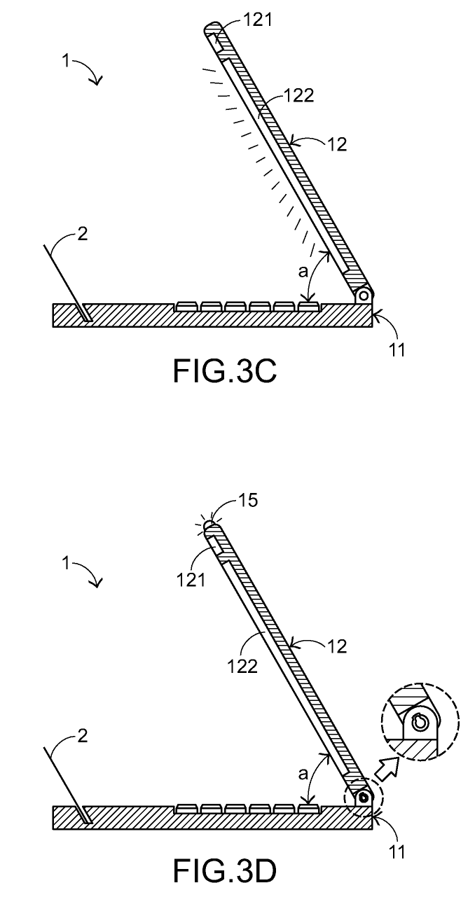

FIG. 3A is a schematic side view illustrating an exemplary positioning auxiliary device used in the notebook computer 1 of the present invention. The positioning auxiliary device is a sound generating device 14. If the included angle a between the upper cover 12 and the base 11 is within a preset angle range, a sound prompt is generated by the sound generating device 14 to notify the user. In this embodiment, the sound generating device 14 is a built-in or external loudspeaker or bee buzzer. It is preferred that the preset angle range is greater than 10° and smaller than 90°. Depending on the size of the notebook computer 1 and the specification of the image sensing device 121, the preset angle range may be varied.

FIG. 3B is a schematic side view illustrating an exemplary positioning auxiliary device used in the notebook computer 1 of the present invention. The positioning auxiliary device is a lighting device 15. If the included angle a between the upper cover 12 and the base 11 is within a preset angle range, a light beam is generated by the lighting device 15 to notify the user. In this embodiment, the lighting device 15 is a built-in or external light emitting diode (LED) indicator. It is preferred that the preset angle range is greater than 10° and smaller than 90°. Depending on the size of the notebook computer 1 and the specification of the image sensing device 121, the preset angle range may be varied.

FIG. 3C is a schematic side view illustrating another exemplary positioning auxiliary device used in the notebook computer 1 of the present invention. The screen 122 is also acted as positioning auxiliary device. If the included angle a between the upper cover 12 and the base 11 is within a preset angle range, a flashing picture is shown on the screen 122 to notify the user. It is preferred that the preset angle range is greater than 10° and smaller than 90°. Depending on the size of the notebook computer 1 and the specification of the image sensing device 121, the preset angle range may be varied.

FIG. 3D is a schematic side view illustrating an exemplary positioning auxiliary device used in the notebook computer 1 of the present invention. The positioning auxiliary device is a tenon 16, which is mounted within the rotating shaft 13. If the included angle a between the upper cover 12 and the base 11 is within a preset angle range, a noise is generated by the tenon 16 to notify the user. In addition, the included angle between the upper cover 12 and the base 11 is retained by the tenon 16. It is preferred that the preset angle range is greater than 10° and smaller than 90°. Depending on the size of the notebook computer 1 and the specification of the image sensing device 121, the preset angle range may be varied.

From the above description, it is found that the fixing recess of the notebook computer is capable of facilitate fixing the card. After the image pickup program is opened, a proper included angle between the upper cover 12 and the base 11 is adjusted by the positioning auxiliary device. Next, the image of the card 2 will be captured automatically or in response to a triggering action of the user when the user depresses a triggering key on the keyboard 111. After the image of the card 2 is captured by the image sensing device 121, the image data is recognized, filed or stored by associated software or hardware components of the notebook computer 1.

An example of the card 2 to be captured by the image sensing device of the notebook computer of the present invention includes but is not limited to a business card, a photograph, a credit card, a debit card, an identification card, an envelope, a postcard, a ticket card, a notepaper, a bookmark and the like.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A notebook computer for capturing an image of a card, said notebook computer comprising:
a base comprising a keyboard and a fixing recess for fixing said card; and
an upper cover pivotally coupled to said base and comprising an image sensing device and a screen for displaying a frame, wherein said frame on said screen has a first luminance value if said image sensing device is disenabled to capture said image of said card, and said frame on said screen has a second luminance value greater than said first luminance value if said image sensing device is enabled to capture said image of said card.

2. The notebook computer according to claim 1 wherein a white frame is displayed on said screen if said image sensing device is enabled to capture said image of said card.

3. The notebook computer according to claim 1 wherein said notebook computer further comprises a touch pad, whose level is lower with respect to a top surface of said base, so that an indentation between said top surface of said touch pad and said base is defined as said fixing recess.

4. The notebook computer according to claim 1 wherein said fixing recess is a groove comprising an entrance and an inclined channel.

5. The notebook computer according to claim 4 wherein said entrance is located in a top surface of said base.

6. The notebook computer according to claim 4 wherein said entrance is located in a front surface of said base.

7. The notebook computer according to claim 4 wherein said entrance is located in a junction between a top surface of said base and a front surface of said base.

8. The notebook computer according to claim 1 wherein said notebook computer further comprises a sound generating device, wherein a sound prompt is generated by said sound generating device if an included angle between said upper cover and said base is within a preset angle range.

9. The notebook computer according to claim 1 wherein said sound generating device is a loudspeaker.

10. The notebook computer according to claim 8 wherein said preset angle range is greater than 10° and smaller than 90°.

11. The notebook computer according to claim 1 wherein said notebook computer further comprises a lighting device, wherein a light beam is emitted by said lighting device if an included angle between said upper cover and said base is within a preset angle range.

12. The notebook computer according to claim 11 wherein said lighting device is a light emitting diode.

13. The notebook computer according to claim 11 wherein said preset angle range is greater than 10° and smaller than 90°.

14. The notebook computer according to claim 1 wherein a flashing picture is shown on said screen if an included angle between said upper cover and said base is within a preset angle range.

15. The notebook computer according to claim 14 wherein said preset angle range is greater than 10° and smaller than 90°.

16. The notebook computer according to claim 1 wherein said upper cover is pivotally coupled with said base about a rotating shaft, and a tenon is mounted within said rotating shaft, such that a noise is generated if an included angle between said upper cover and said base is within a preset angle range.

17. The notebook computer according to claim 16 wherein said included angle between said upper cover and said base is retained by said tenon.

18. The notebook computer according to claim 16 wherein said preset angle range is greater than 10° and smaller than 90°.

19. The notebook computer according to claim 1 wherein said notebook computer further comprises a switch, and said switch is triggered to allow said image sensing device to capture said image of said card if an included angle between said upper cover and said base is within a preset angle range.

20. The notebook computer according to claim 19 wherein said switch is a key of said keyboard.

21. The notebook computer according to claim 19 wherein said preset angle range is greater than 10° and smaller than 90°.

22. The notebook computer according to claim 1 wherein said image sensing device is an image pickup device.

23. The notebook computer according to claim 22 wherein said image pickup device is a network camera.

24. The notebook computer according to claim 22 wherein said image pickup device is a camera.

25. The notebook computer according to claim 1 wherein said card is selected from a group consisting of a business card, a photograph, a credit card, a debit card, an identification card, an envelope, a postcard, a ticket card, a notepaper and a bookmark.
